(19) United States
(12) Patent Application Publication
(10) Pub. No.: US 2014/0113257 A1
(43) Pub. Date: Apr. 24, 2014

(54) AUTOMATED EVALUATION OF PROGRAMMING CODE

(71) Applicants: Alexey N. Spiridonov, Mountain View, CA (US); Andrey Goder, San Jose, CA (US)

(72) Inventors: Alexey N. Spiridonov, Mountain View, CA (US); Andrey Goder, San Jose, CA (US)

(21) Appl. No.: 13/655,201

(22) Filed: Oct. 18, 2012

(51) Int. Cl. G09B 19/00

(52) U.S. Cl. CPC G09B 19/0053
USPC 434/118

(57) ABSTRACT

Evaluating code is disclosed. A configuration associated with a programming problem is determined. A random input data is generated. The programming problem based at least in part on the determined configuration is provided. An output data that corresponds to the random input data is received. The output data was generated by a code responsive to the programming problem. The output data is evaluated.

### BACKGROUND OF THE INVENTION

Typically during the interview process of a programmer, a candidate is asked to program/solve a programming problem during the interview process to enable the interviewer assess to the programming skills of the candidate. In some cases, a candidate is asked to solve the coding problem online at a remote location. This may allow the interviewer to screen a large number of candidates efficiently. However, it is difficult to generate a programming problem that is both unique and reproducibly difficult for each candidate for the same job function. If the programming problem is not sufficiently unique, the candidate may utilize the work of another that has previously solved the same and/or similar programming problem as the solution of the candidate. Additionally, the difficulty level of a programming problem for one candidate should be comparable to a difficulty level of another programming problem for another candidate to enable comparability of the candidates. Therefore, there exists a need for a better way to generate a programming problem.

### BRIEF DESCRIPTION OF THE DRAWINGS

Various embodiments of the invention are disclosed in the following detailed description and the accompanying drawings.

FIG. 1 is a block diagram illustrating an embodiment of a programming problem generation and evaluation environment.

FIG. 2 is a flow chart illustrating an embodiment of a process for generating a programming problem and evaluating a user response.

FIG. 3 is a flow chart illustrating an embodiment of a process for generating a programming problem.

FIG. 4 is a flowchart illustrating an embodiment of a process for evaluating a solution to a programming problem.

### DETAILED DESCRIPTION

The invention can be implemented in numerous ways, including as a process; an apparatus; a system; a composition of matter; a computer program product embodied on a computer readable storage medium; and/or a processor, such as a processor configured to execute instructions stored on and/or provided by a memory coupled to the processor. In this specification, these implementations, or any other form that the invention may take, may be referred to as techniques. In general, the order of the steps of disclosed processes may be altered within the scope of the invention. Unless stated otherwise, a component such as a processor or a memory described as being configured to perform a task may be implemented as a general component that is temporarily configured to perform the task at a given time or a specific component that is manufactured to perform the task. As used herein, the term ‘processor’ refers to one or more devices, circuits, and/or processing cores configured to process data, such as computer program instructions.

A detailed description of one or more embodiments of the invention is provided below along with accompanying figures that illustrate the principles of the invention. The invention is described in connection with such embodiments, but the invention is not limited to any embodiment. The scope of the invention is limited only by the claims and the invention encompasses numerous alternatives, modifications and equivalents. Numerous specific details are set forth in the following description in order to provide a thorough understanding of the invention. These details are provided for the purpose of example and the invention may be practiced according to the claims without some or all of these specific details. For the purpose of clarity, technical material that is known in the technical fields related to the invention has not been described in detail so that the invention is not unnecessarily obscured.

Generating and evaluating a programming problem is disclosed. In some embodiments, a programming problem is automatically and randomly generated and a user provided solution to the programming problem is automatically evaluated. For example, a user is provided a randomly generated example input and a corresponding output of a correct solution program to the programming problem, and the user is to generate a computer code that can use the example input to generate the corresponding output. In generating the programming problem, a programming problem type is selected among one or more programming problem types. For example, a programming problem type is selected among one or more of the following: a web programming problem type, a regular expression matching programming problem type, and a graphical rendering programming problem type (e.g., utilizing turtle graphical programming language). For the determined programming problem type, one or more of the following may be randomly determined: a programing problem configuration, an input data, and an output data.

For example, if a web programming problem type is selected, the generated programming problem asks a user to produce program code that can reproduce a webpage such as a provided example output webpage using an input data such as a provided input data. In another example, if a regular expression matching programming problem type is selected, the generated programming problem asks a user to produce program code that finds within an input data, instances of a desired character pattern as shown in provided output data that includes pattern matches from one or more provided example input text. This may require the user to study the example input text and the corresponding match outputs to determine the character pattern to be found by a solution of the programming problem. The desired character pattern may be associated with a new regular expression matching operator and the programming problem may require a user to implement the new operator. In another example, if a graphical output programming problem type is selected, the generated programming problem asks a user to produce program code that can reproduce a provided output graphical image using one or more provided programming language elements starting from a provided graphical starting point.

In some embodiments, the user's code and/or one or more outputs processed by the user's computer code may be automatically evaluated. For example, the user provides a user generated computer code in response to the programming problem and/or outputs generated by the user generated computer code using one or more provided test inputs. The provided code and/or outputs may be automatically evaluated. For example, an evaluation score may be generated.

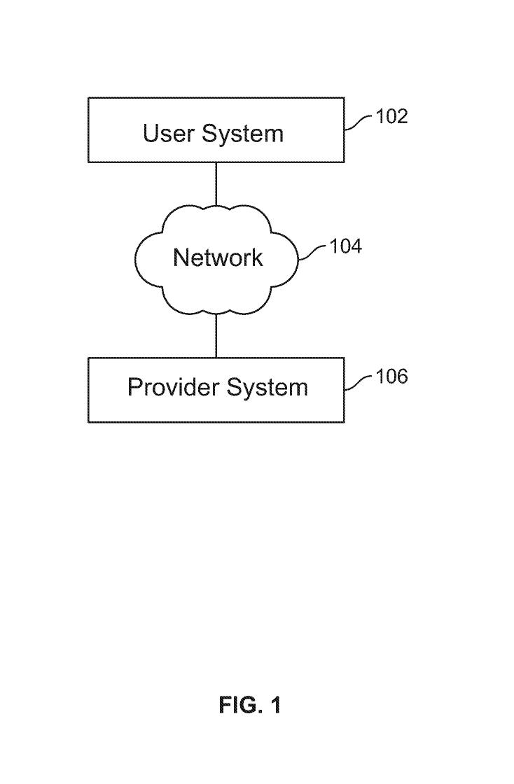

FIG. 1 is a block diagram illustrating an embodiment of a programming problem generation and evaluation environment. User system 102 communicates with provider system 106 via network 104. In some embodiments, user system 102 obtains a programming problem from provider system 106 via network 104. For example, user system 102 includes a computer device used by an employment candidate and the candidate obtains a programming problem to be solved by the candidate via an Internet webpage hosted at least in part by provider system 106.

In some embodiments, provider system 106 at least in part randomly generates the programming problem. The programming problem may include a description of the programming problem, an example input data to be processed by a solution of the programming problem and/or an example output data of a correct solution to the programming problem. A user may utilize user system 102 and/or another system to solve the programming problem. In some embodiments, the programming problem is to be solved in a computer code development environment provided by provider system 106. For example, a computer code input editor interface and/or a compiler may be at least in part provided by provider system 106. In some embodiments, the computer code development environment may be at least in part executed on user system 102. For example, compute code editing, compilation, and/or execution of a user generated solution to the programming problem may be in part or entirely executed on user system 102 to protect the security of provider system 106. In some embodiments, at least a portion of the computer code development environment may be executed by provider system 106. For example, computer code editor and compiler may be executed by provider system 106.

In some embodiments, user system 102 provides to provider system 106 via network 104 information that can be used to evaluate a user solution to the provided programming problem. For example, provider system 106 may provide to user system 102 via network 104, one or more test input data to be processed by a user generated computer code solution to the programming problem and user system 102 executes the user solution using the provided test input data and provides one or more results of the execution to provider system 106 for evaluation. In another example, user system 102 provides the user solution computer code to provider system 106 for evaluation. The evaluation may be performed automatically. For example, the provided information is compared with a reference solution and a score is generated based at least in part on an automatic comparison of the provided information with the reference solution.

In various embodiments, the components shown in FIG. 1 may exist in various combinations of hardware machines. The components of FIG. 1 may communicate with another component via network 104. Although single instances of components have been shown to simplify the diagram, additional instances of any of the components shown in FIG. 1 may exist. For example, additional instances of user systems may communicate with provider system 106 and/or user system 102 may communicate with a plurality of provider systems. Components not shown in FIG. 1 may also exist. Examples of network 104 include one or more of the following: a direct or indirect physical communication connection, mobile communication network, Internet, intranet, Local Area Network, Wide Area Network, Storage Area Network, and any other form of connecting two or more systems, components, or storage devices together. Any number of components may be included in user system 102. Example components of user system 102 include a personal computer, a laptop computer, a tablet computer, a mobile device, a display device, a user input device, and any other device that may be used to receive, process, and/or solve a programming problem. Any number of components may be included in provider system 106. Example components of provider system 106 include a server, a database, a storage device, a processing component, and another component that can be used to generate a programming problem and/or evaluate a solution to the programming problem.

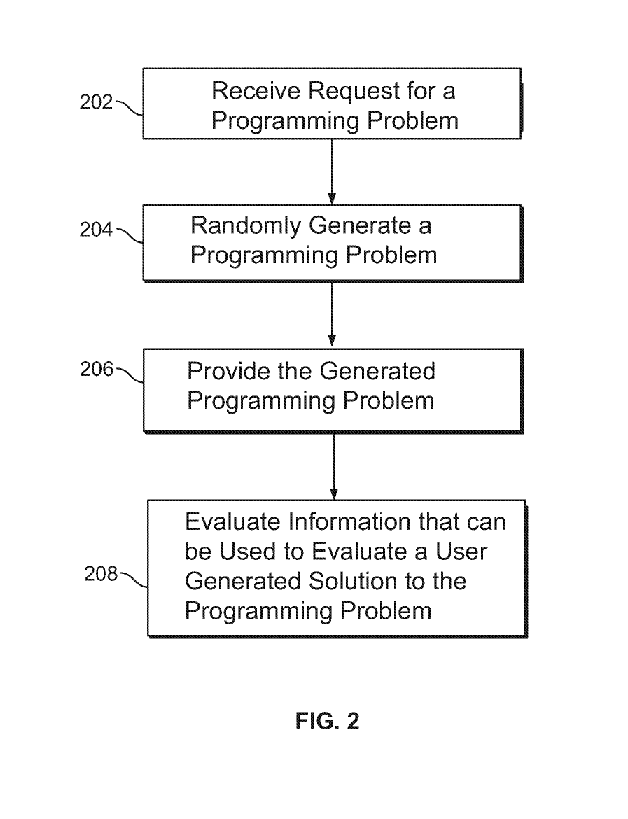

FIG. 2 is a flow chart illustrating an embodiment of a process for generating a programming problem and evaluating a user response. The process of FIG. 2 may be implemented on one or more components included in provider system 106 of FIG. 1. At 202, a request for a programming problem is received. In some embodiments, the request is received from a user system such as user system 102 of FIG. 1. The request may be received from a user desiring to demonstrate a programming ability of the user. In some embodiments, the request is received as a part of an employment interview process. In some embodiments, the request includes information that can be used to determine a particular type of programming problem to be provided. For example, a programming language to be utilized and a difficulty level of the programming problem may be dynamically determined/matched based at least in part on the received information.

At 204, a programming problem is randomly generated. In some embodiments, generating the programming problem includes selecting at random a programing problem type to be utilized among one or more predetermined programming problem types. For example, a programming problem type is selected among one or more of the following: a web programming problem type, a regular expression matching programming problem type, and a graphical output programming problem type (e.g., utilizing a turtle graphics programming language such as a Logo programming language developed by Wally Feurzeig and Seymour Papert). In some embodiments, for the determined programming problem type, one or more of the following are randomly determined: a programing problem configuration, an example input data, and an example output data. In some embodiments, generating the programming problem includes at least in part randomly generating an example input data to be utilized by a user generated solution to the programming problem. A corresponding output data that should be outputted by a correct solution to the programming problem may be generated and included in the programming problem to be utilized as a reference output.

At 206, the generated programming problem is provided. In some embodiments, the generated programming problem is provided to user system 102 of FIG. 1 to be solved by a user of system 102. In some embodiments, the programming problem is associated with a time limit and information that can be used to evaluate a solution to the programming problem is to be provided within the time limit. In some embodiments, the programming problem includes a description of the configuration of a programming problem to be solved, an example input data, and a corresponding example output data. For example, the generated programming problem includes a description of a webpage to be generated, a description of an input database configuration, a database including example input data, and a corresponding output webpage to be reproduced by a solution to the programming problem. In some embodiments, the programming problem includes a computer code library that may be utilized to solve the programming problem.

At 208, information that can be used to evaluate a user generated solution to the programming problem is evaluated. In some embodiments, the user provides a user generated computer code in response to the programming problem and/or outputs generated by the user generated computer code using one or more provided test inputs. The provided code and/or outputs may be automatically evaluated. In some embodiments, evaluating the information includes executing at least a portion of a user generated code. In some embodiments, evaluating the information includes comparing the received information with reference information. In some embodiments, evaluating the information includes generating a score, ranking, and/or other quantitative/qualitative metrics of correctness of a user solution to the programming problem. The reference information may be generated using a universal solver program and/or predetermined and selected from a library of predetermined reference information. In some embodiments, evaluating the information includes determining an authenticity of the user generated solution. For example, a user may have copied at least a portion of programming code written by another or used an automated code generator to generate the solution. Detecting the authenticity may include comparing at least a portion of the user generated solution to one or more previously submitted solutions and/or a library of solutions that can be used to detect the authenticity of the user generated solution.

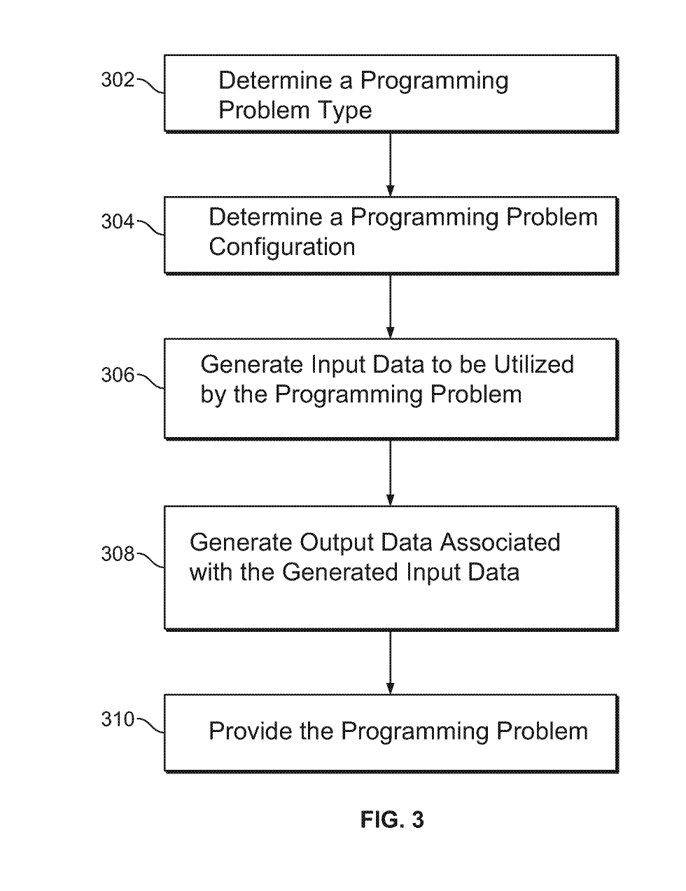

FIG. 3 is a flow chart illustrating an embodiment of a process for generating a programming problem. The process of FIG. 3 may be implemented on provider system 106 of FIG. 1. In some embodiments, the process of FIG. 3 is included in step 204 of FIG. 2.

At 302, a programming problem type is determined. In some embodiments, determining the programming problem type includes selecting one programming problem type from a group of predetermined programming problem types. For example, a programming problem type is selected among one or more of the following: a web programming problem type, a regular expression matching programming problem type, and a graphical output programming type (e.g., using a turtle graphical programming language). In some embodiments, the determined programming problem type determines the type of programming problem to be provided. For example, if a web programming problem type is selected, a programming problem that requires a user to build a webpage program is to be provided. In another example, if a regular expression matching programming problem type is selected, a programming problem that requires a user to build a specified regular expression matcher is to be provided. In another example, if a graphical output programming problem type is selected, a programming problem that requires a user to build a graphical renderer using turtle graphics is to be provided.

In some embodiments, the programming problem type may be determined at random from a group of possible programming problem types. In some embodiments, the programming problem type is at least in part determined based on information associated with an intended user of a programming problem. For example, the programming problem type is determined to match a skill, desired job, knowledge, experience, and/or job function associated with an intended user. In some embodiments, the selected programming problem type is associated with one or more implementing programming languages. For example, if a web programming problem type is selected, a user may be allowed to utilize any of a plurality of implementing web programming languages (e.g., Javascript, PHP, Perl, Ruby, Python, ASP.net, etc.) to build a web program.

At 304, a programming problem configuration is determined. For example, a configuration is determined for the type of programming problem determined at 302. In some embodiments, the programming problem configuration includes one or more of the following: a programming language allowed to be used to solve the programming problem, a programming constraint, a data relationship/dependency, an allowed programming element, an allowed programming library element, and a time limit. In some embodiments, at least a portion of the programming problem configuration is randomly determined. For example, a particular configuration element is selected at random among a plurality of possible configuration elements. In some embodiments, at least a portion of the programming configuration is determined based at least in part on another configuration element. For example, a configuration element is determined due to another element that has been randomly determined. In some embodiments, at least a portion of the programming configuration is dynamically determined. For example, a configuration element is dynamically determined based on provided information about an intended user of a programming problem (e.g., to match a skill, desired job, knowledge, experience, and/or job function of the intended user). In some embodiments, determining the programming problem configuration includes dynamically adjusting a difficulty level of a programming problem being generated.

In some embodiments, determining the programming problem configuration for a web programming problem type includes determining one or more of the following: a type of webpage to be rendered, one or more desired webpage elements, a source content database schema, one or more web programming languages to be utilized, and one or more allowed programming library elements that can be utilized to solve the programming problem. Determining the database schema may include dynamically determining schema of a database containing one or more tables that contain input data to be utilized to render a desired webpage. Associations between one or more tables/columns of the database, a configuration of data stored in the database, and/or types of database elements stored in the database may be dynamically and/or randomly determined. Determining the desired webpage rendering elements may include dynamically determining which elements (e.g., from a plurality of possible webpage elements and/or data that can be rendered) should be rendered by a solution of the programming problem being generated.

In some embodiments, determining the programming problem configuration for a regular expression matching problem type includes determining one or more of the following: a specification of a regular expression matcher to be programmed, one or more desired expression matching elements, a new regular expression operator to be implemented in a solution to the programming problem, one or more programming languages to be utilized, one or more regular expression operators that are allowed to be utilized to solve the programming problem, and one or more allowed programming library elements that can be utilized to solve the programming problem. In some embodiments, the regular expression matcher to be programmed cannot be programmed by simply utilizing/implementing a standard regular expression library. For example, the regular expression matcher to be programmed finds adjacent characters/numbers that are offset in sequence by a specified gap (e.g., for a gap of 2, “ace”, “df”, “npsu” and “2468” would match but “56” with a gap of 1 would not match). In another example, the regular expression matcher to be programmed finds in an input text any substring of a specified string that is equal or longer than a specified length of characters (e.g., for a specified length of 4 and specified string “supercalifragilisticexpialidocious”, substrings such as “ifra” and “alidoc” would be matched but “fra” (too short) or “bazooka” (not contained in the specified string) would not be matched). Any of the programming problem configuration elements may be randomly and/or dynamically determined.

In some embodiments, determining the programming problem configuration for a graphical rendering problem type includes determining one or more of the following: a specification of the graphical renderer to be programmed, one or more graphical elements to be rendered, one or more programming languages to be utilized, and one or more allowed programming library elements that can be utilized to solve the programming problem. In some embodiments, determining the programming problem configuration for the graphical rendering problem type includes determining rendering tools and/or rending commands allowed to be utilized to solve the programming problem. For example, in a turtle graphical language, the directions a turtle is allowed to turn is limited by the programming problem configuration (e.g., only allowed to turn “N”, “NE”, “E”, “SE”, “S”, “SW”, “W” and “NW” directions but not allowed to turn in arbitrary numerical degree directions). In some embodiments, determining the programming problem configuration for the graphical rendering problem type includes determining a rendering canvas parameter (e.g., triangular, square, or hexagonal grid type, grid size, pixel size, pixelation of a canvas, vector graphics support, etc.). Any of the programming problem configuration elements may be randomly and/or dynamically determined.

At 306, an input data to be utilized by the programming problem is generated. In some embodiments, generating the input data includes randomly generating data to be utilized by a solution program code of the programming problem being generated. For example, generating the input data includes populating a database/table with data selected at random from a library of possible data. In another example, generating the input data includes randomly selecting at least a portion of an input data to be used to match a regular expression. In another example, generating the input data includes randomly determining a starting position and/or starting element of a graphical rendering. In some embodiments, the generated input data includes an example input data to be included in the programming problem as an example input data to be utilized by a solution program to the generated programming problem. In some embodiments, the generated input includes one or more test inputs to be utilized to evaluate a solution to the programming problem being generated. The test inputs may not be provided with the programming problem and may be utilized only during a solution evaluation process.

At 308, an output data associated with the generated input data is generated. In some embodiments, generating the output data includes determining a corresponding desired output of a correct solution to the programming problem being generated when provided at least a portion of the input data generated in 306 as an input. This output data may be generated by a universal solver that is able to generate a correct output given the determined programming problem configuration and the generated input data. In some embodiments, the universal solver is able to determine a correct output for all possible variations of a particular type of programming problem that can be randomly generated using the process of FIG. 3. A different universal solver may be used for each different type of programming problem. For example, a universal regular expression matcher may be used to determine a solution to a particular regular expression matching programming problem. In some embodiments, the generated output data includes an example output data to be included in the programming problem as an example output data. In some embodiments, the generated output data includes a desired output associated with a test input data to be utilized to evaluate a solution to the programming problem being generated. The test output data may not be provided with the programming problem and may be utilized only during a solution evaluation process.

At 310, a programming problem is provided. In some embodiments, the programming problem is provided using at least a portion of the determined/generated items. For example, the programming problem includes data associated with the determined programming problem type, determined programming problem configuration, at least a portion of the generated input data, and at least a portion of the generated output data. In some embodiments, the programming problem includes a description of the programming problem that is at least in part dynamically generated based at least in part on the programming problem configuration determined in 304.

In one example, for a web programming problem, the programming problem includes a schema of an input database, a specification of which element of the input database to render on a webpage, a database including example data to be rendered, and an example output data including an example webpage to be reproduced by a solution. In another example, for a regular expression matching programming problem, the programming problem includes one or more examples of an input text data, corresponding regular expression matching result output data, and a specification of programming elements that can be used to solve the programming problem. In another example, for a graphical rendering programming problem, the programming problem includes an output graphical rendering to be reproduced, a specification of a starting position and/or rendering, and a specification of programming elements that can be used to solve the programming problem.

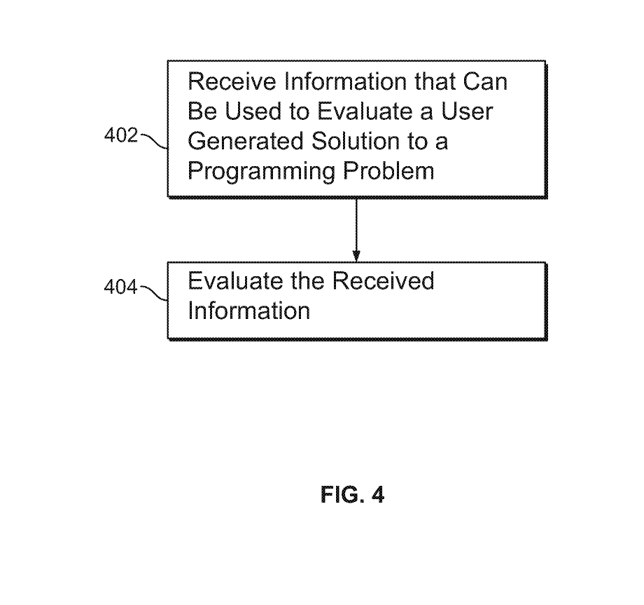

FIG. 4 is a flowchart illustrating an embodiment of a process for evaluating a solution to a programming problem. The process of FIG. 4 may be implemented on one or more components of provider system 106 of FIG. 1. In some embodiments, the process of FIG. 4 is included in step 208 of FIG. 2. At 402, information that can be used to evaluate a user generated solution to a programming problem is received. In some embodiments, the received information includes computer code written by a user in response to the programming problem. In some embodiments, the received information includes an output of a user generated computer program solution in response to the programming problem. For example, one or more test input data are provided and corresponding output(s) generated by the solution program after processing the test input data is provided for evaluation.

At 404, the received information is evaluated. The information received in step 402 is evaluated. In various embodiments, the evaluation is performed automatically without human intervention. In some embodiments, at least a portion of the evaluation is performed at a human evaluator. In some embodiments, evaluating the information includes comparing the received information with reference information. For example, a received output data of a programming problem solution is compared with a known correct output generated in step 308 of FIG. 3. In another example, a received user generated code is compared with a reference code.

In some embodiments, before the received information is evaluated, the received information is processed. For example, whitespace and/or variable names included in the received information may be eliminated and/or modified. In some embodiments, alternative representation of the received information may be generated before being evaluated. For example, the received information is parsed into a hierarchical structure (e.g., tree structure) before being evaluated. In some embodiments, evaluating the information includes executing at least a portion of a user generated code. For example, the user generated code is executed and tested using test input data determined at step 306 of FIG. 3. The output data of the execution is compared with a reference output data to determine a result of the evaluation. In some embodiments, evaluating the information does not include executing a user generated code to protect security of an evaluating system. For example, test input data determined at step 306 of FIG. 3 is provided to a user system and the user system executes the user generated code and provides a result of the execution to a provider system for evaluation.

In some embodiments, evaluating the information includes generating a score, ranking, and/or other quantitative/qualitative metrics of correctness of a user solution to the programming problem. For example, a score is generated based at least in part on a similarity of the received information to corresponding reference information. Point values may be assigned to each portion of a correction solution and the assigned point values for each portion are earned if the portion matches a corresponding portion of reference information. The final score may be determined by summing the earned portion point values. In some embodiments, an evaluation score is based at least in part on one or more of the following: ability to parse a provided information used to evaluate the user solution, amount of time utilized to solve the programming problem, length of program code utilized to solve the programming problem, computational efficiency of the user solution, ability to handle errors, and ability to handle incorrect input data.

Although the foregoing embodiments have been described in some detail for purposes of clarity of understanding, the invention is not limited to the details provided. There are many alternative ways of implementing the invention. The disclosed embodiments are illustrative and not restrictive.

What is claimed is:

1. A system for evaluating code, comprising:
a processor configured to:
determine a configuration associated with a programming problem;
generate a random input data;
provide the programming problem based at least in part on the determined configuration;
receive an output data that corresponds to the random input data, wherein the output data was generated by a code responsive to the programming problem; and
evaluate the output data; and
a memory coupled to the processor and configured to provide the processor with instructions.

2. The system of claim 1, wherein the system is configured to automatically evaluate the output data without human intervention.

3. The system of claim 1, wherein the programming problem is a web programming problem type associated with rendering a webpage.

4. The system of claim 1, wherein the programming problem is a regular expression matching programming problem type associated with locating a desired pattern within text content.

5. The system of claim 1, wherein the programming problem is a graphical rendering programming problem type associated with a turtle graphics rendering.

6. The system of claim 1, wherein the programming problem is provided as a part of an employment interview process.

7. The system of claim 1, wherein the processor is further configured select at random one programming problem type from a group of predetermined programming problem types and the programming problem is based at least in part on the randomly selected programming problem type.

8. The system of claim 1, wherein the programming problem is at least in part determined based on information associated with an intended user of the programming problem.

9. The system of claim 1, wherein the configuration is associated with one or more of the following: a programming language, a programming constraint, a data relationship, a data dependency, an allowed programming element, an allowed programming library element, and a time limit.

10. The system of claim 1, wherein determining the configuration includes dynamically determining at least a portion of the configuration.

11. The system of claim 1, wherein determining the configuration includes randomly determining a schema of a database that will contain the random input data.

12. The system of claim 1, wherein at least a portion of the random input data is included in the programming problem as an example input data.

13. The system of claim 1, wherein the random input data includes test input data that is utilized when evaluating the output data.

14. The system of claim 1, wherein the processor is further configured to generate a reference output data corresponding to the random input data.

15. The system of claim 14, wherein at least a portion of the reference output data is included in the programming problem as an example output data.

16. The system of claim 14, wherein evaluating the received output data includes comparing the received output data with the reference output data.

17. The system of claim 1, wherein evaluating the output data includes evaluating the code.

18. The system of claim 1, wherein evaluating the output data includes determining a quantitative metric associated with a correctness of the code.

19. A method for evaluating code, comprising:
determining a configuration associated with a programming problem;
generating a random input data;
providing the programming problem based at least in part on the determined configuration;
receiving an output data that corresponds to the random input data, wherein the output data was generated by a code responsive to the programming problem; and
using a processor to evaluate the output data.

20. A computer program product for evaluating code, the computer program product being embodied in a tangible computer readable storage medium and comprising computer instructions for:
determining a configuration associated with a programming problem;
generating a random input data;
providing the programming problem based at least in part on the determined configuration;
receiving an output data that corresponds to the random input data, wherein the output is data was generated by a code responsive to the programming problem; and
evaluating the output data.
